(19) United States
(12) Patent Application Publication
(10) Pub. No.: US 2007/0086684 A1
(43) Pub. Date: Apr. 19, 2007

(54) Retaining device for rolling-element and the method for manufacturing the same

(75) Inventors: Chun-Liang Wu, TAICHUNG (TW); Chin-Pei Wang, TAICHUNG (TW)

Correspondence Address: BANGER SHIA, 204 CANYON CREEK, VICTORIA, TX, 77901, US

(73) Assignee: HIWIN TECHNOLOGIES CORP., TAICHUNG (TW)

(21) Appl. No.: 11/567,737

(22) Filed: Dec. 7, 2006

Related U.S. Application Data
(63) Continuation-in-part of application No. 10/949,106, filed on Sep. 24, 2004, now abandoned.

(51) Int. Cl. F16C 19/00

(52) U.S. Cl. 384/51

(57) ABSTRACT

The present invention relates to a retaining device for rolling-element and its manufacturing method, which is made up of the partition and the link-ring. The characteristic of the retaining device for rolling-element is that the partition is a hollow-ring-like structure to separate the rolling-elements, and the link-ring joins the partitions to become an unitary structure. Besides, the characteristic of the manufacturing method of the retaining device is use a bat to pass through the shaping mold, therefore reducing the degree of difficulty of manufacture, and saving the cost of manufacture.

This application is a continuation of part of U.S. patent application Ser. No. 10/949,106 filed on Sep. 24, 2004, which claims the benefit of the earlier filing date of Sep. 24, 2004.

### BACKGROUND OF THE INVENTION

1. Field of the Invention

The present invention relates to a retaining device for rolling-element, which is mainly used on the linear transmission unit, and the linear transmission unit is mostly used on the mechanical, the electronic, the auto and the semiconductor equipments.

2. Description of the Prior Arts

The retaining devices for rolling-element used on the conventional linear transmission unit are generally divided into two types: the first type retaining device is an independent single unit, and the second type retaining device is made up of many single units. When assembling the linear transmission unit equipped with the first type retaining device, the producer has to put the rolling-elements and the retaining device into the sliding block alternatively one by one, so the assembly requires a lot of time. Furthermore, the single retaining device and the rolling-elements need to contact each other properly, the rolling-elements are likely to disengage from the retaining device if the clearance between the rolling-elements and the retaining device is too large, and they are likely to contact the sidewall of the circulating path when moving in a return path. Thus, it is not flexible for the rolling-elements to change the moving direction. Besides, the rolling-elements may be jammed in the return path. On the other hand, an obvious friction resistance will be produced if clearance between the rolling-elements and the retaining devices is too close, so that the rolling-elements are unable to move smoothly. Thereby, it is very difficult to control the clearance between the rolling-elements and the retaining device, and as well known in the art, the clearance between the rolling-elements and the retaining device will be increased after a certain time of use. In this case, the clearance will still be increased even if the clearance between the rolling-elements and the retaining device has been controlled very precisely during the production.

The second type retaining device is made up of many single units (such as the devices disclosed in U.S. Pat. Nos. 5,988,883, 6585,417, IP Patent publication No. H05-052217 or H05-231432). In these prior arts, the retaining device comprises plural partitions, which are linked one after another by a flexible chain, and the rolling-elements are disposed between two neighboring partitions. Since the partitions are linked one another by the flexible chain, the rolling-elements are unlikely to be disengaged from the space between the partitions. However, the second type retaining device should be assembled by putting the rolling elements into mold, and then enclosing the mold with plastic ejection. And the requirement on the quality of the plastic material and the performance of the plastic ejection machine is very strict, and thus the cost is relatively increased. Furthermore, due to the special manufacturing method, the contact between the rolling-elements and the partitions is too tight, and no lubrication can be stored or circulated among the rolling-elements since the partitions are sealed in cross section and the contact area between the partitions and the rolling-elements is too large (which is full-surface contact), this will result in a great friction and will affect the movement of the rolling-elements. The retaining device is made by a spherical mold, thus the contact surface of the retaining device used to contact the rolling-elements is a concave-spherical surface. The contact between the concave-spherical surface and the rolling-elements is almost a full-surface contact. As is well known, the whole-surface contact is uneasy to be lubricated and its friction force will be great. As a result, the rolling resistance for the rolling-elements will be increased. Some designs have been used to deal with the lubrication problem, for example, the concave-spherical surface of the retaining device is designed not to fully abut against the surface of the rolling-elements (for example, the concave-spherical surface is formed with wave threads, or the radius of curvature of the concave-spherical surface is a little different from that of the rolling-elements), so as to produce a micro clearance between the concave-spherical surface and the rolling-elements for permitting the lubrication to flow therethrough, thus reducing the friction resistance. However, the retaining device itself will be worn out since it is made of plastic or rubber material. Furthermore, the plastic and the rubber material have a great deformability, when the pressure between the concave-spherical surface of the retaining device and the rolling-elements is increased, or when the concave-spherical surface of the retaining device is wom out after a certain time of use, the contact between the concave-spherical surface of the retaining device and the rolling-elements will be turned into full-surface contact, and the friction force therebetween will be increased.

In addition, according to the conventional method of manufacturing the rolling-element retaining device, the rolling-elements act as a core of the mould. Initially, the rolling-elements are installed in the mold and processed with plastic ejection. This manufacturing method has the following problems: First, the number of rolling-elements is adjusted according to the size of the retaining device, if the retaining device is kind of long, the number of the rolling-elements is relatively large, thus, the assembly time will be relatively long. Second, since the mold according to this manufacturing method is made up of an upper half die and a lower half die which are released from each other in the upper and down direction when demolding, so the concave-spherical surface will not be very deep, and the radius of curvature of the concave-spherical surface will be close to that of the rolling-elements. When the pressure between the concave-spherical surface of the retaining device and the rolling-elements is great, or when the concave-spherical surface of the retaining device is worn out after a certain time of use, the contact between the concave-spherical surface of the retaining device and the rolling-elements will be turned into full-surface contact, and the friction resistance therebetween will be increased. Third, due to the mold is made up of the upper and the lower half dies, the partition between two retaining devices cannot be defined with a through hole. Defining a through hole on the partitions can bring many advantages. However, the conventional manufacturing method is unable to make such a through hole on the partitions of the conventional retaining device. Fourth, it is time-consuming since the conventional manufacturing method has to put the rolling-elements into the mold one by one.

The present invention has arisen to mitigate and/or obviate the afore-described disadvantages.

### SUMMARY OF THE INVENTION

A retaining device for rolling-element in accordance with the present invention is a unitary structure capable of retaining and making the rolling elements move continuously and smoothly in the circulating path. To deal with the problems of the conventional retaining device for rolling-element, the retaining device of the present invention is specially formed with a through hole for storage of the lubrication, thus the rolling-elements can be lubricated enough. Furthermore, the through hole doesn't contact the rolling-elements at all. In this case, the through hole doesn't contact the rolling-elements and remain with lubrication even when there is friction caused between the rolling-elements and the retaining device. Thereby, the rolling elements and the retaining device can be effectively separated from each other and lubricated.

The unitary structure of the retaining device for rolling-element in accordance with the present invention is simple in structure and generally including two parts: a plurality of partitions and a chain. The partitions are hollow-ring-like structure and employed to separate the rolling-elements from each other. The chain serves to connect the partitions and form a unitary structured retaining device.

The partitions are provided with a through hole so as to form a hollow-ring-like structure, both sides of the respective partitions are rectangle-shaped in cross section, such that the contact area between the partitions and the rolling-elements are reduced.

Due to the structural characteristic of the present invention, the chain of the retaining device for rolling-element in accordance with the present invention will be curved when moving in the return path, thus a gap is formed between the partitions and the rolling-elements so as to connect the through hole with the return path, and thus, the lubrication in the return path can move into the through hole. The through hole will be fully sealed by the rolling-elements again when the retaining device starts to move straight after passing the return path, thus, the through hole can be effectively stored with lubrication. When the rolling-elements are moving straight, the lubrication in the through hole will produce an oil film on the surface of the rolling-elements, thus lubricating the rolling-elements and the retaining device effectively.

The retaining device is produced by plastic ejection molding, and the mold comprises an upper die and a lower die, a bat runs through the mold of the retaining device and is used to form a plurality of hollow-ring-like structures in a plurality of partitions of the retaining device.

A method for manufacturing a retaining device for rolling-element in accordance with the present invention includes the following steps: first, putting the bat into an lower die of the mold; then covering an upper die formed with pouring openings on the lower die; next injecting plastic into the mold; after that, taking off the bat, removing the upper die and taking the retaining device off the lower die; thus, the retaining device is obtained. The advantage of the mold is that the upper and the lower dies can be provided with a structure for supporting and positioning the bat. And the structure is similar to a bridge pier which can provide enough support for the bat to counteract the ejecting pressure during the process of plastic ejection molding, thus improving the durability of the mold and the qualified rate of the retaining device.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a retaining device for rolling-element in accordance with the present invention;

FIG. 2 is a partial amplified cross sectional view of the retaining device for rolling-element in FIG. 1;

FIG. 3 shows the retaining device for rolling-element in accordance with the present invention is changing the moving direction;

FIG. 4 is an exploded view of a mold for manufacturing the retaining device for rolling-element;

FIG. 5 shows different ways of ejection molding the rolling-elements;

FIG. 6 is a chart of friction force comparison between different rolling-element retaining devices that are used linear transmission unit;

FIG. 7a is an illustrative view in accordance with the present invention of showing a retaining device with a constant cross section;

FIG. 7b is a cross sectional view of the retaining device taken along the line A-A of FIG. 7a;

FIG. 8a is an illustrative view in accordance with the present invention of showing a retaining device with a variable cross section formed to match configuration of the rolling elements;

FIG. 8b is a cross sectional view of the retaining device taken along the line A-A of FIG. 8a;

FIG. 9 is a first coordination chart of showing the variation of the maximum contact force between the retaining device and the guiding groove;

FIG. 10 is a second coordination chart of showing the variation of the maximum contact force between the retaining device and the guiding groove;

FIG. 11 is a third coordination chart of showing the variation of the maximum contact force between the retaining device and the guiding groove; and

FIG. 12 is a fourth coordination chart of showing the variation of the maximum contact force between the retaining device and the guiding groove.

### DETAILED DESCRIPTION OF THE PREFERRED EMBODIMENTS

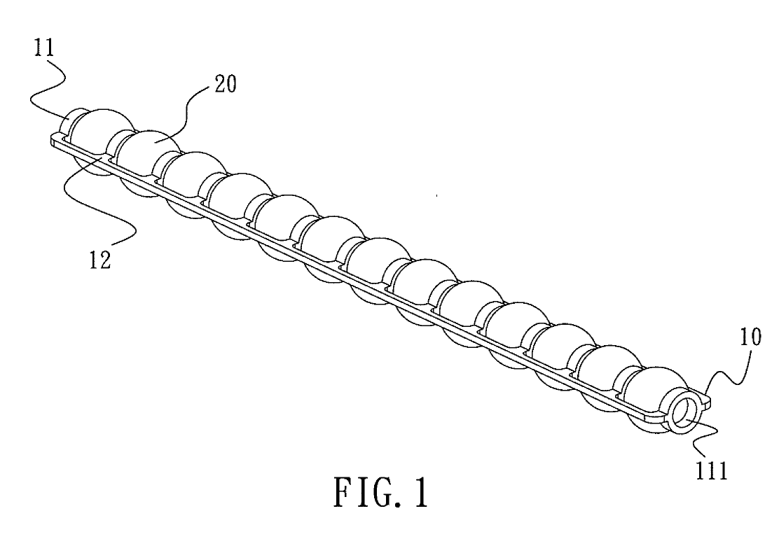

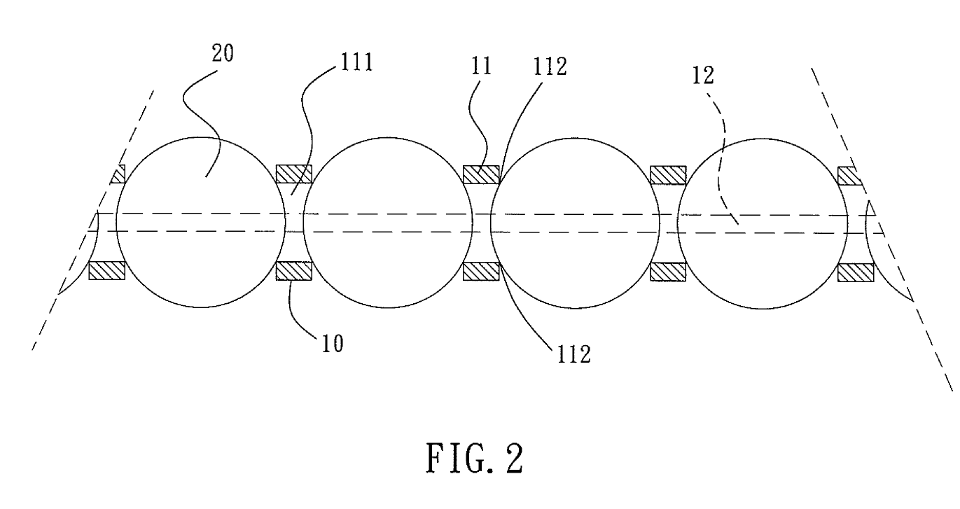

Referring to FIG. 1, which is a perspective view of a retaining device for rolling-element in accordance with the present invention. FIG. 2 is a partial amplified cross sectional view of the retaining device for rolling-element in FIG. 1. A plurality of rolling-elements 20 are retained in the retaining device 10, and the retaining device 10 comprises a plurality of partitions 11 and a chain 12. Each of the partitions 11 is axially formed with a through hole 111, such that the partition 11 is ring-shaped to separate the rolling-elements 20 from one another. To reduce the contact area between the rolling-elements 20 and the partitions 11, both sides of the partition 11 are rectangle-shaped in cross section, such that the contact area between the rolling-elements 20 and the partitions 11 is the contact points 112. The contact between the rolling-elements 20 and the partitions 11 is in the shape of an annular line, and the contact area is reduced. Meanwhile, the through hole 111 is sealed by the rolling-elements 20 from both sides, thus creating a receiving space for storage of lubrication. The chain 12 serves to link the respective partitions 11 together, thus constituting the retaining device 10. Since the contact area between the rolling-elements 20 and the partitions 11 are made up of the contact points 112, and the through hole 111 between the neighboring rolling-elements 20 can be used to store the lubrication, the contact area between the rolling-elements 20 and the partitions 11 will not be increased too much even if the contacting points 112 are worn out, at least in the area of the through hole 111, no friction will be caused between the rolling-elements 20 and the partitions 11. Moreover, the through hole 111 is filled with lubrication for providing good lubricating effect for the rolling-elements 20 and the partitions 11.

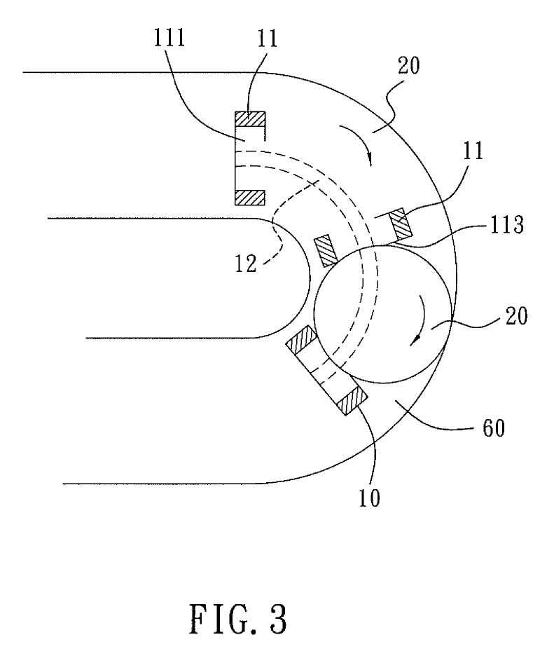

FIG. 3 shows the retaining device for rolling-element in accordance with the present invention is changing the moving direction. The rolling-elements 20 and the partitions 11 are moving in a return path 60 to change the moving direction. At this moment, the chain 12 of the retaining device 10 is curved for enabling the rolling-elements 20 and the partitions 11 to change their moving direction. Meanwhile, a gap 113 is formed between the through hole 111 of the partitions 11 and the rolling-elements 20 so as to connect the through hole 111 with the return path 60, and thus, the lubrication in the return path 60 can move into the through hole 111. The through hole 111 will be fully sealed by the rolling-elements 20 again when the retaining device 10 starts to move straight after passing the return path 60, thus, the through hole 111 can be effectively stored with lubrication.

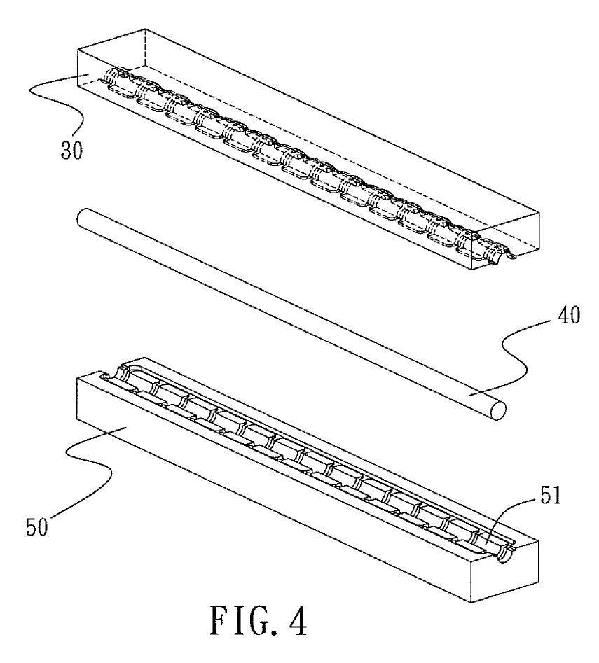

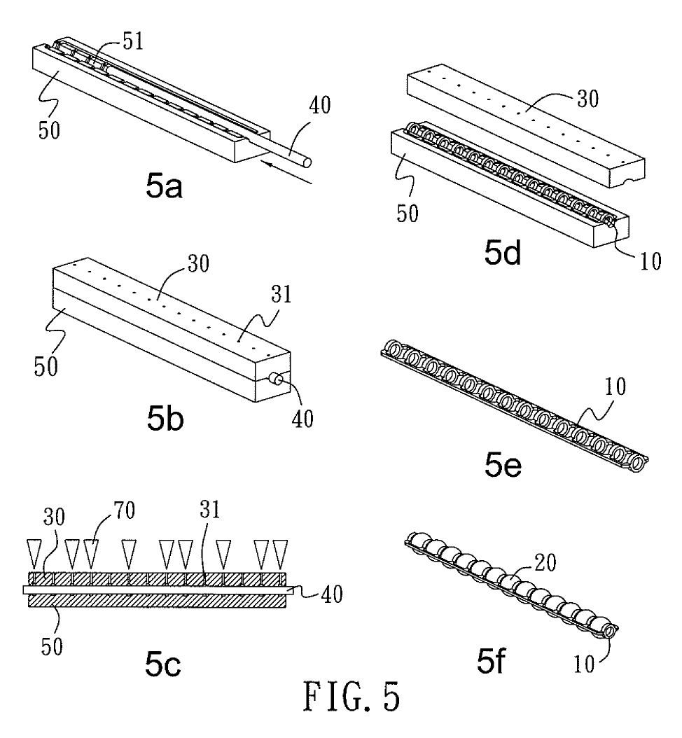

The present invention uses a special manufacturing method to produce the retaining device 10 formed with the through hole 111. FIG. 4 is an exploded view of a mold for manufacturing the retaining device 10 for rolling-element. FIG. 5 shows different ways of ejection molding the rolling-elements 20. The mold comprises an upper die 30, a bat 40 and a lower die 50. The upper die 30 and the lower die 50 constitute the outer shape of the retaining device 10, and the bat 40 runs through the inner space formed by the upper die 30 and the lower die 50. Referring to FIGS. 5a-5f, the manufacturing method includes the following steps: putting the bat 40 into a groove 51 of the lower die 50; then covering the upper die 30 formed with pouring openings 31 on the lower die 50; next forming the retaining device 10 by aligning plastic-feeding holes 70 to the pouring openings 31 of the upper die and injecting the plastic; after that, taking off bat 40, de-molding the upper die, and taking the retaining device 10 off the lower die 50; finally, putting the rolling-elements 20 into the finished retaining device 10, thus, the rolling-elements 20 can be guided by the retaining device 10 and are separated from each other.

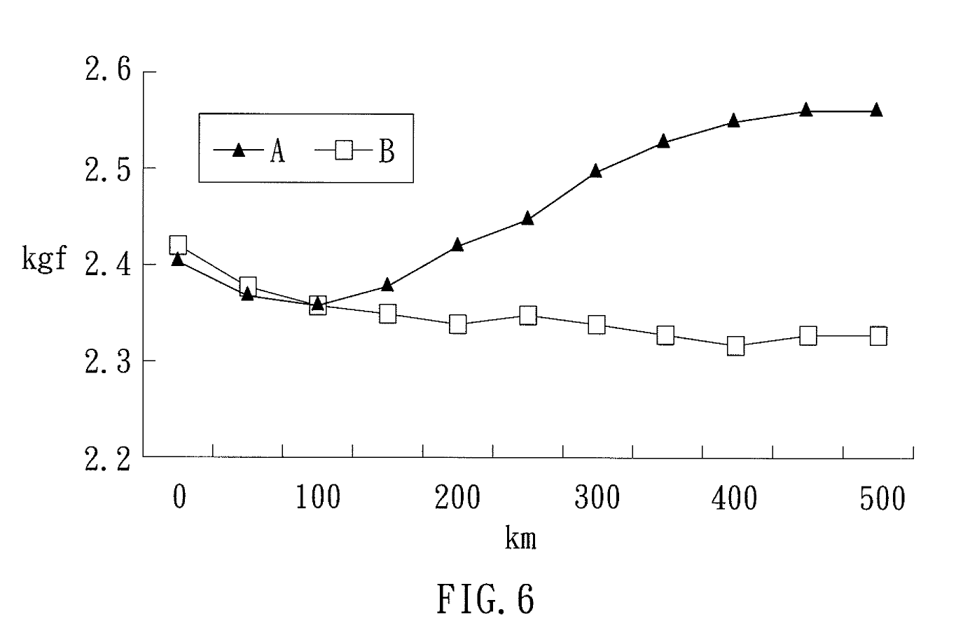

FIG. 6 is a chart of friction force comparison between different rolling-element retaining devices that are used linear transmission unit. The horizontal axis indicates the accumulated displacement of the linear transmission unit, the unit is kilometer (km). The vertical axis shows the friction force caused by the linear transmission unit during movement, and the unit is kilogram (kg). The linear transmission unit is tested under such a condition that the linear transmission unit is unloaded and will be lubricated once per hour, linearly reciprocating at a maximum speed of 1 meter per second. And then the friction force is measured when the accumulated displacement runs up to 50 km, 100 km, 150 km . . . The results show the friction changes of a retaining device (indicated by A) which is not provided with a through hole but a concave-spherical surface. Within the initial 100 km, the friction force is decreased a little due to the friction reduces the interference between the rolling-elements and the contact surface of the retaining device, thus reducing the friction force slightly. However, the friction force is increased sharply later on, the reason is because the contact between the concave-spherical surface and the rolling-elements is gradually turning into a full-surface contact after the concave-spherical surface is worn out, plus lack of lubrication. When the accumulated displacement approaches 450-500 km, the increasing rate of the friction force slows down because the contact between the concave-spherical surface and the rolling-elements has turned into a full-surface contact. The test also shows a retaining device for rolling-element having through hole in accordance with the present invention (indicated by B). Due to friction is also caused between the concave-spherical surface and the rolling-elements, the friction force is decreased at the initial stage, and then it tends to be stable. During 500 km testing, the friction force is not increased.

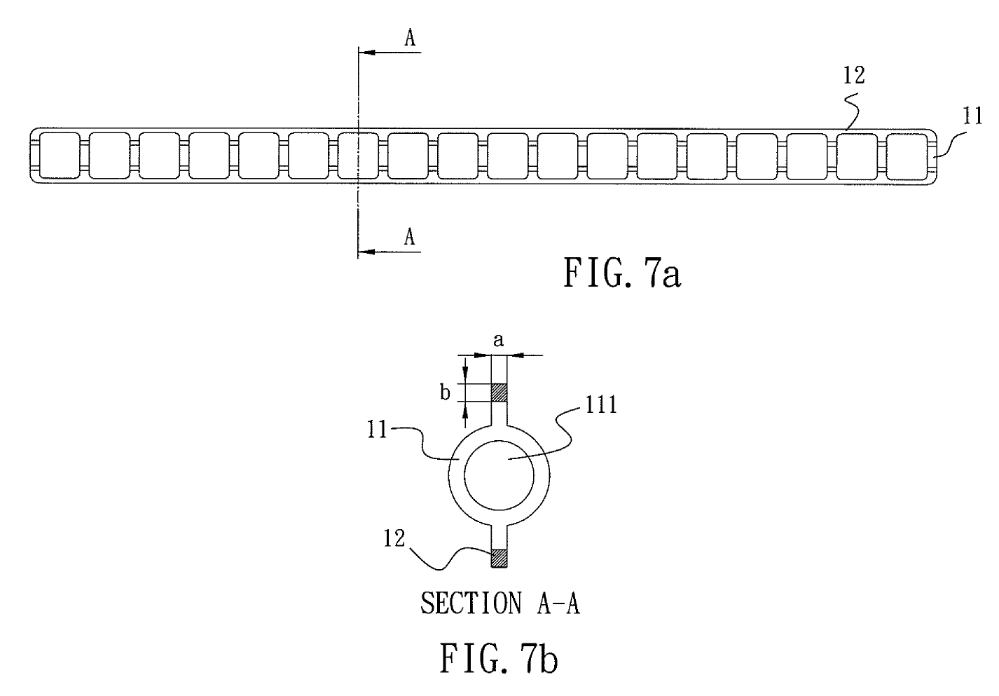

Referring to FIGS. 7a and 7b, the cross section of the chain 12 is a constant rectangle having a thickness a and a width b. in order to obtain the aforementioned advantages, the thickness a should be smaller than the width b.

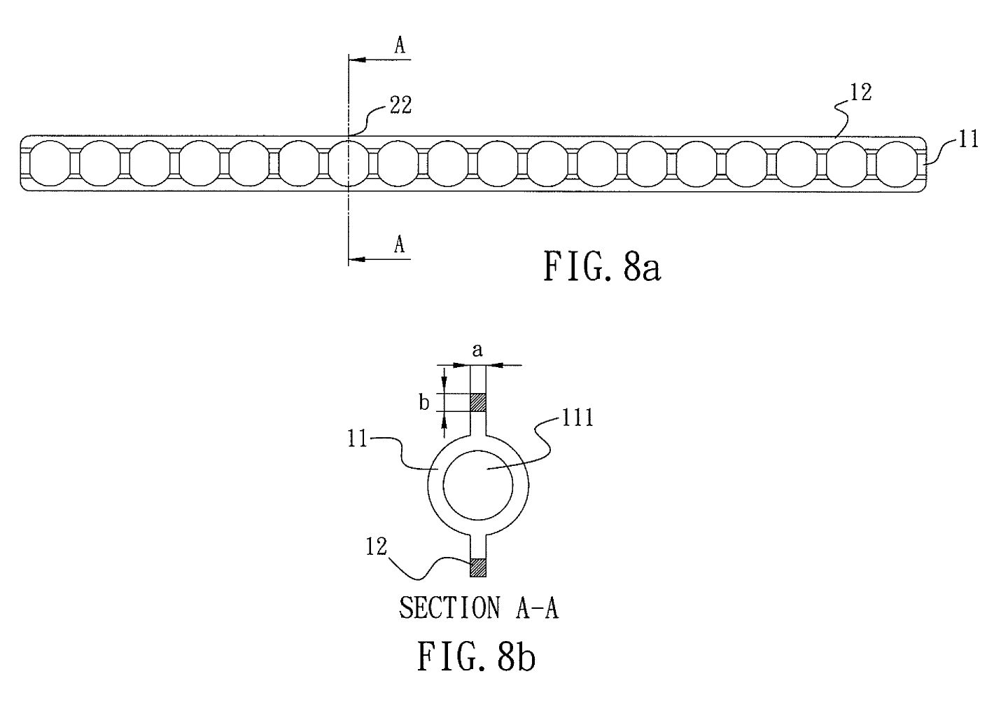

Referring to FIGS. 8a and 8b, to improve the structural strength of the chain 12, the cross section of the chain 12 is tapered to match the configuration of the rolling elements, the center 22 of the chain 12 is the place where the value of the ratio of the thickness to the width (namely, a/b) is the largest, wherein the thickness a<the width b, so as to restrict the direction in which the chain-shaped retaining device is bent.

To summarize, the chain is an elongated structure with a constant cross section and serves to connect the partitions together to form a chain-shaped retaining device. The chain is rectangular-shaped in cross section, and the cross section of the chain is such a structure whose width is larger than the thickness thereof. There are two purposes of such arrangements: first to enable the rolling-element retaining device to improve the resistance to deformation and reduce the drag force when it passes through the return path as shown in FIG. 3, thus the retaining device can circulate smoothly; and second to restrict the direction in which the chain-shaped retaining device is bent, improving the operation stability.

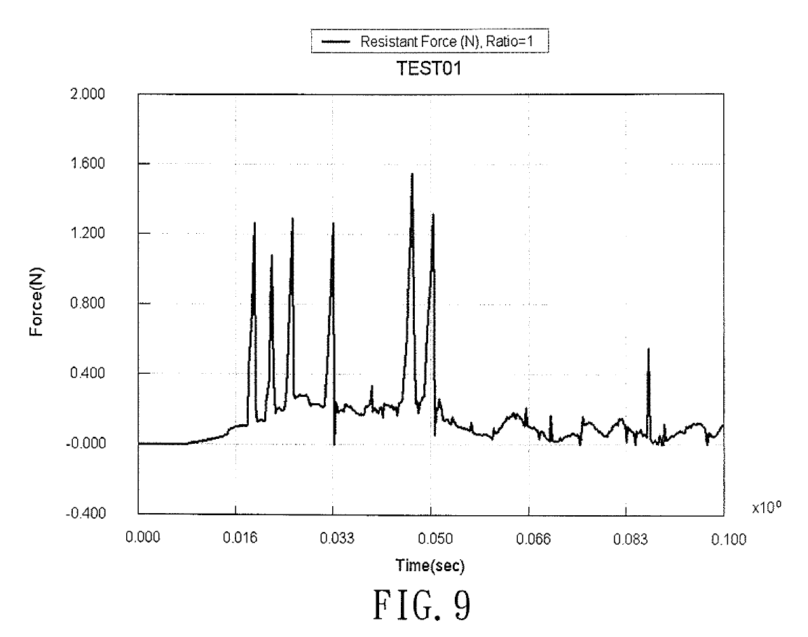

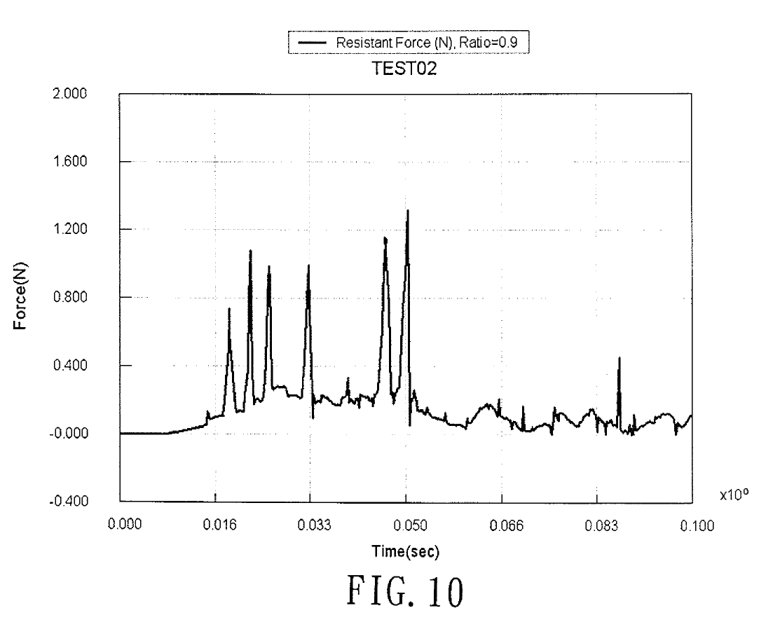

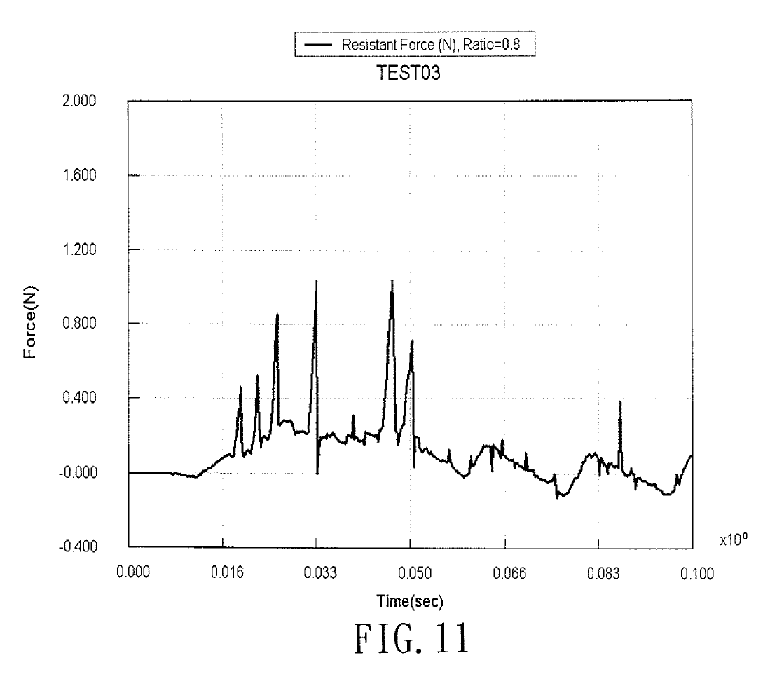

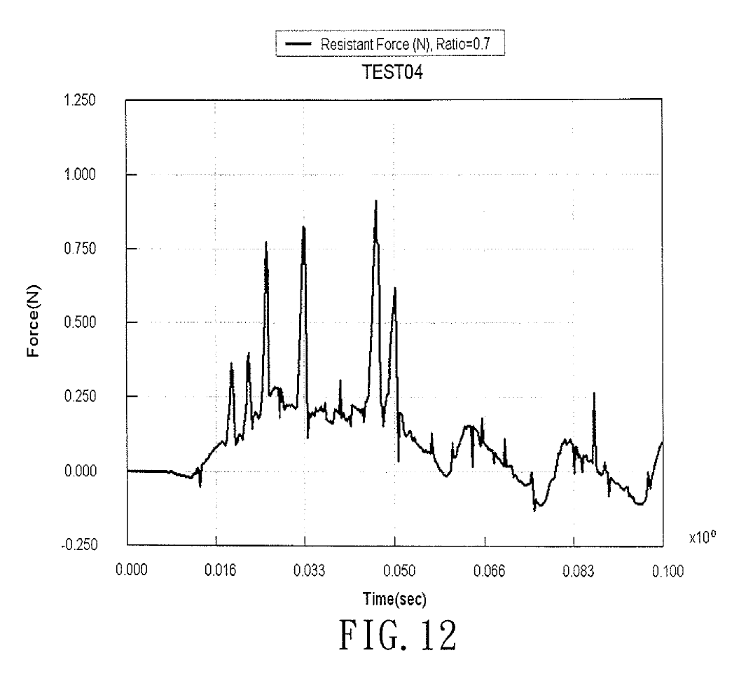

Further, we use dynamic analysis software to analyze the deformation and the resistance of the different rolling-element retaining devices of the same width but with different thickness. The deformation status of the flexible retaining device within the circulation path is illustrated in the attached drawing 1. And FIGS. 9-12 show the variation of the maximum contact force between the retaining device and the guiding groove under the condition of constant velocity and the size ratio (thickness to width ratio) of the cross section is 1, 0.9, 0.8, and 0.7. The analysis results show that it is much of help in improving the turning ability of the retaining device if the size ratio of the cross section is less than 1.

In addition, to provide a chain of the retaining device with improved strength, the chain is designed to have a variable cross section shaped to match the configuration of the rolling elements. Therefore, the cross section of the chain is a tapered rectangular cross section, and we also made similar analysis (as shown in the attached drawing 2). In order to obtain the aforementioned objective, the cross section of the chain should be sized such that the width is always larger than the thickness.

While we have shown and described various embodiments in accordance with the present invention, it should be clear to those skilled in the art that further embodiments may be made without departing from the scope of the present invention.

What is claimed is:

1. A retaining device for rolling-element employed to accommodate and to retain a plurality of rolling elements, and comprising:
a plurality of ring-shaped partitions serving to separate the rolling-elements from one another;
a chain being an elongated structure with a constant cross section and serving to connect the partitions together to form a chain-shaped retaining device, the chain being rectangular-shaped in cross section, and the cross section of the chain is such a structure whose width is larger than the thickness thereof.

2. A retaining device for rolling-element employed to accommodate and to retain a plurality of rolling elements, and comprising:
a plurality of ring-shaped partitions serving to separate the rolling-elements from one another;
a chain being an elongated structure with a variable cross section formed to match configuration of the rolling elements, and serving to connect the partitions together to form a chain-shaped retaining device, the chain being rectangular-shaped in cross section, and the cross section of the chain is such a structure whose minimum width is larger than the thickness thereof.

3. The retaining device for rolling-element as claimed in claim 1, wherein both sides of each of the partitions are rectangle-shaped in cross section, so as to reduce the contact area between the rolling-elements and the partitions.

4. The retaining device for rolling-element as claimed in claim 2, wherein both sides of each of the partitions are rectangle-shaped in cross section, so as to reduce the contact area between the rolling-elements and the partitions.

5. The retaining device for rolling-element as claimed in claim 1, wherein each of the partitions is a ring-like hollow round pipe.

6. The retaining device for rolling-element as claimed in claim 2, wherein each of the partitions is a ring-like hollow round pipe.
